(19) United States
(12) Patent Application Publication
(10) Pub. No.: US 2026/0028250 A1
(43) Pub. Date: Jan. 29, 2026

(54) METHOD AND APPARATUS FOR DISPOSING HYDROGEN SULFIDE

(71) Applicant: ExxonMobil Technology and Engineering Company, Spring, TX (US)

(72) Inventors: Sean A. MASON, Houston, TX (US); Keith H. KUECHLER, Friendswood, TX (US); Lucas M. SANDER, Stirling, NJ (US)

(21) Appl. No.: 19/247,793

(22) Filed: Jun. 24, 2025

Related U.S. Application Data
(60) Provisional application No. 63/674,463, filed on Jul. 23, 2024.

(51) Int. Cl. C02F 1/28; C02F 1/04; C02F 101/10; C02F 103/16

(52) U.S. Cl. CPC C02F 1/28; C02F 1/046; C02F 2101/101; C02F 2103/16

(57) ABSTRACT

A composition, apparatus, and method for enabling improved disposal of hydrogen sulfide are disclosed. An exemplary embodiment provides a method. The method includes receiving a brine stream comprising hydrogen sulfide. The method includes removing the hydrogen sulfide from the brine stream to generate hydrogen sulfide gas and a pretreated brine stream. The method includes processing the pretreated brine stream to produce a return brine stream. The method includes combining the hydrogen sulfide gas with the return brine stream under compression to generate a disposable waste stream.

### CROSS-REFERENCE TO RELATED APPLICATION

This application claims priority to and the benefit of U.S. Provisional Application No. 63/674,463, entitled “METHOD AND APPARATUS FOR DISPOSING HYDROGEN SULFIDE,” having a filing date of Jul. 23, 2024, the disclosure of which is incorporated herein by reference in its entirety.

### FIELD

The present techniques generally relate to removal and disposal of gases from brines. More specifically, the present techniques are directed towards methods and apparatuses for disposing of hydrogen sulfide gas generated by chemical processes.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 50,000 to 450,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments.

### SUMMARY

An exemplary embodiment provides an apparatus. The apparatus includes a system to receive a brine stream comprising hydrogen sulfide. The apparatus further includes a system to remove the hydrogen sulfide from the brine stream to generate hydrogen sulfide gas and a pretreated brine stream. The apparatus includes a system to process the pretreated brine stream to produce a return brine stream. The apparatus further includes a system to combine the hydrogen sulfide gas with the return brine stream under compression to generate a disposable waste stream.

Another exemplary embodiment provides a method. The method includes receiving a brine stream comprising hydrogen sulfide. The method also includes removing the hydrogen sulfide from the brine stream to generate hydrogen sulfide gas and a pretreated brine stream. The method includes processing the pretreated brine stream to produce a return brine stream. The method includes combining the hydrogen sulfide gas with the return brine stream under compression to generate a disposable waste stream.

Another exemplary embodiment provides a treated brine composition. The composition includes a treated brine having a concentration of hydrogen sulfide within a range of 0.01 to 7,000 parts per million (ppm) by weight, and a concentration of lithium within a range of 0.01 to 1,000 ppm by weight.

These and other features and attributes of the disclosed embodiments of the present disclosure and their advantageous applications and/or uses will be apparent from the detailed description that follows.

### BRIEF DESCRIPTION OF THE DRAWINGS

The advantages of the present techniques are better understood by referring to the following detailed description and the attached drawings, in which:

FIG. 1 is an illustration of an apparatus for the extraction of lithium from a lithium-containing brine, according to embodiments herein;

FIG. 2 is an illustration of an apparatus for the disposal of hydrogen sulfide, according to an embodiment;

FIG. 3 is an illustration of an apparatus for the removal of hydrogen sulfide from brines using a stream stripper, according to another embodiment;

FIG. 4 is an illustration of an apparatus for the removal of hydrogen sulfide from brines under vacuum using a vacuum flash, according to another embodiment;

FIG. 5 is an illustration of an apparatus for separate acid gas compression and reinjection, according to an embodiment;

FIG. 6 is an illustration of an apparatus for combined acid gas compression and reinjection using a liquid gas ejector, according to an embodiment; and

FIG. 7 is a process flow diagram of a method for producing a direct lithium extraction feed, according to another embodiment.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

As used herein, the following terms shall have the following meanings.

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “deep subsurface brine” refers to a saline solution that has circulated through rocks deep in reservoirs such as those found in East Texas, North Dakota, and Arkansas in the United States, and in Alberta, Canada.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a DLE process.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, precipitates of iron oxides include iron oxides, iron hydroxides, iron oxide-hydroxides and iron oxyhydroxides.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

As used herein, “sour gas” refers to natural gas or any other gas containing significant amounts of hydrogen sulfide (H2S).

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

The term “synthetic brine” refers to a brine that has been prepared such that it simulates a naturally occurring brine. For instance, a synthetic brine can be prepared in an attempt to simulate the brine composition of various geothermal brine reservoirs found in the Salton Sea region (Calif, USA). Generally, the synthetic brine simulating a Salton Sea geothermal brine has a composition of about 280 ppm lithium, 63,000 ppm sodium, 20,000 ppm potassium, 33,000 ppm calcium, 130 ppm strontium, 700 ppm zinc, 1700 ppm iron, 450 ppm boron, 50 ppm sulfate, 3 ppm fluoride, 450 ppm ammonium ion, 180 ppm barium, 160-ppm silica (reported as SiOz), and 180,000 ppm chloride. Additional elements, such as manganese, aluminum, antimony, bromine, chromium, cobalt, copper, fluorine, lead, arsenic, mercury, molybdenum, nickel, silver, thallium, and vanadium, may also be present in the brine.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables from 50% to greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfide (H2S). The present technological innovation generally relates to compositions for preventing sorbent poisoning and pipe corrosion. These techniques generally relates to treated brine compositions with reduced concentrations of H2S that can also be used for recovery of metals, including lithium, manganese, rubidium, cesium, and potassium.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

Accordingly, existing methods for pond-assisted DLE may not work with deep well brines, which may not have been targeted because of the reasons discussed above. In addition, geothermal brines come out at significantly higher pressure and higher temperatures of more than 300 degrees F. Thus, such geothermal brines may not have the same issues of organic matter in the liquid because such organics may flash off with the higher temperatures and pressures and thus not make it into the untreated brine from the geothermal sources. Therefore, such methods may not take the removal of organic matter present in deep subsurface wells into account.

Moreover, regarding pretreatment of brine, some methods aim at removing gases such as hydrogen sulfide gas prior to treatment of the brine by a DLE process. However, such methods may not fully address the problems present in disposing of such extracted gases. For example, most of the lithium processing methods may not focus on the resulting gas from the reservoirs as the focus has been on the use of evaporation ponds. Thus, such methods do not address the implications of any gas coming out of the ground for lithium production. Moreover, treatment options currently being used such as in-field sparging and a dedicated sulfur plant are very costly.

In particular, lithium produced from brine will contain gas, which can be some amount of H2S, CH4, CO2, NH3, and other light end components. In the pretreatment step, this gas is separated from the brine to protect the DLE sorbent. Then, the CH4 and CO2 can be isolated from H2S and NH3 for different processing. Preliminary estimates of the brine are ˜500-5,000 ppm by weight of H2S. Some of this H2S can be flashed out from the liquid in the gas phase, whereas the rest of the H2S will remain in solution and need to be removed via H2S stripping or other separation processes. Preliminary measurements are that there is 5-20 standard cubic feet (SCF) Gas/BBL of brine, with 60-85% by volume being H2S. The remaining H2S in the brine is expected to be between 100-3,000 ppm by weight. However, because the H2S cannot be vented to the atmosphere and because burning would produce hazards, the only main alternative to disposal of H2S is a costly sulfur processing plant to convert it to elemental sulfur.

Accordingly, embodiments described herein enable efficient disposal of gases such as hydrogen sulfide in brine extraction processes. The embodiments described herein focus on the use of a waste brine stream to absorb the waste gas for injection back into the reservoir. The gas can be captured or mixed with the gas in multiple ways, including but not limited to a pump, compressor, liquid ring vacuum pump, and/or a liquid gas ejector. The objective is to introduce compressed H2S and other waste gas directly into the return water pipeline to return the solution in the liquid phase, with likely amounts of full pressurization back into the reservoir. Waste gas is the streams of gas from the system that could include, but is not limited to: H2S, CO2, CH4, NH3, N2, O2, C2H6, and CO.

In one embodiment, a direct lithium extraction process is described with an efficient disposal of hydrogen sulfide generated as a byproduct. A resulting brine composition for improved lithium conversion is also described. The use of such a brine composition may enable increased lithium extraction plant lifetime by reducing the effects of hydrogen sulfide, among other undesirable components. Thus, the techniques may reduce overall disposal costs. The techniques thus also reduce processing needs of a dedicated sulfur plant by providing an efficient manner of returning waste gas into a reservoir.

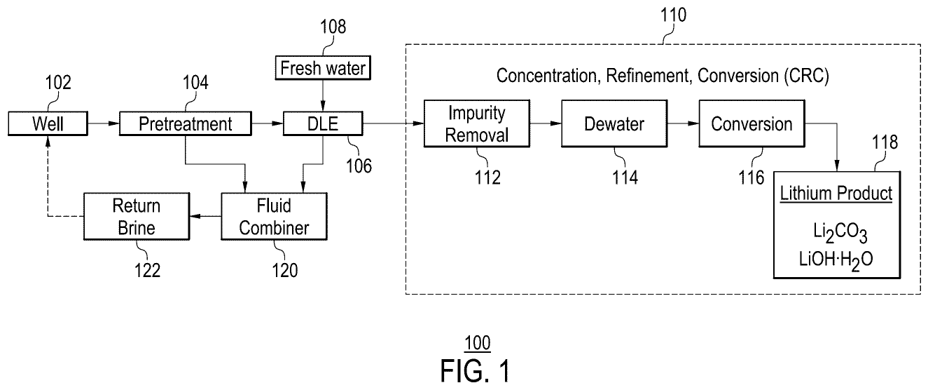

Referring now to FIG. 1, an apparatus 100 for the removal of lithium from a lithium containing brine is provided. A brine containing lithium and other metals is provided via a well 102. The brine received from well 102 may thus be a deep subsurface brine. A lithium enrichment and pretreatment process 104 may then generally pretreat the brine to produce a pretreated brine that is sent to a direct lithium extraction (DLE) process 106, which also receives a fresh water stream 108 and converts the pretreated brine into a lithium rich brine that is sent to a concentration, refinement, and conversion (CRC) system 110.

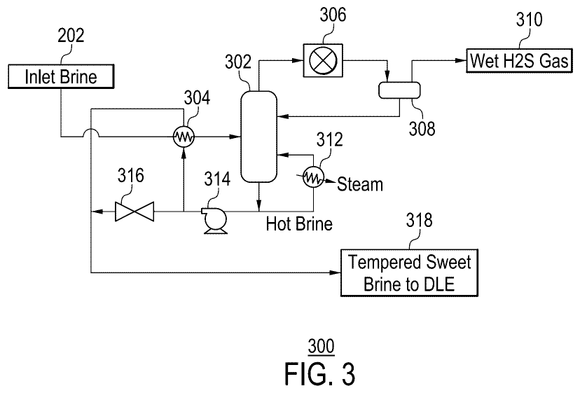

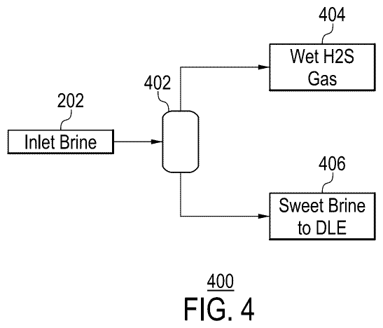

In various embodiments, the pretreatment process 104 may include the use of various technologies, such as the various pretreatment mechanisms and methods of apparatuses 300-400, described in greater detail with respect to FIGS. 3 and 4 below. In various embodiments, the pretreatment process 104 removes hydrogen sulfide (H2S) among other gases from the lithium containing brine.

Pre-treated brine from the pre-treatment process 104 is then processed via a DLE process 106. The DLE process 106 can increase both the ratio of lithium to impurities and the lithium concentration and, regardless of the technique and materials used, this is accomplished by swapping lithium out of the source brine into a fresh water stream 108. In various examples, depending on the techniques applied, additional reagents may also be added to the fresh water stream 108. For example, such reagents may include sodium sulfate (Na2SO4), sodium hydroxide (NaOH), sodium carbonate (Na2CO3), hydrochloric acid (HCl), or sulfuric acid (H2SO4), among other reagents. Each of the steps before and after DLE process 106 are thus tied to the DLE process 106 and the materials used to promote this swap. If impurities in the water would harm the DLE process 106, then these impurities are first removed and this is done in the pre-treatment process 104. For example, hydrogen sulfide (H2S) gas may have been removed from the stream, among other poisons.

The results of the DLE process 106 is a depleted lithium brine that is further processed as describe below, and a lithium rich stream that is sent to the CRC system 110. In various embodiments, the CRC system 110 includes an impurity removal process 112.

The impurity removal process 112 removes any remaining impurities in the lithium water stream. For example, there may be some amount of impurities that remain with the lithium after the DLE process 106 because no material and technique that can perfectly select for lithium may exist. Therefore, the post-DLE impurity removal process 112 may be used to remove any such remaining impurities. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities.

A dewatering process 114 receives purified lithium solution from the impurity removal process 112. For example, after the DLE process 106, the lithium concentration may still be less than an example target concentration of 15,000-70,000 ppm, or an LiCl equivalent of 60,000-420,000 ppm. Therefore, the dewatering process 114 may be applied to remove the water from the purified lithium solution.

In various embodiments, a conversion process 116 then receives purified and concentrated lithium solution from the dewatering process 114 of the CRC system 110. In some embodiments, once all the above enrichment and purification steps are completed, the lithium enriched brine is fed to the conversion process 116 to produce a saleable battery grade lithium product. For example, the conversion process 116 may include the use of a crystallizer that can generate lithium products such as lithium carbonate, lithium hydroxide monohydrate, lithium sulfate, or lithium phosphate, among other lithium products. For example, the lithium product 118 may be lithium carbonate (Li2CO3) or lithium hydroxide monohydrate (LiOH H2O).

In various embodiments, the pre-treatment process 104 generates a depleted lithium brine that is eventually deposited back into the well 102. However, the removed hydrogen sulfide gas, as well as other gases generated during the pretreatment process 104, may be difficult to process and dispose of without further processing and special handling. Therefore, in various embodiments, the depleted lithium brine is combined with the hydrogen sulfide (H2S) from the pre-treatment unit 104 at a fluid combiner 120 to generate a return brine 122 that is injected into the well 102. In various embodiments, the waste brine with depleted lithium is collected from the DLE process 106, combined via the fluid combiner 120 under pressure with the hydrogen sulfide from the pretreatment process 104, and disposed either onto the surface or re-injected into the subsurface reservoir. In some examples, for surface disposal, regulatory approval may be required, and depending on location, large quantities of impurities may need to be removed. In some examples, for reinjection, retention of impurities are required to ensure compatibility with the original subsurface brine. In some embodiments, if too many components are depleted from or added to the spent brine relating to the pretreatment 104 and DLE process 106, then the waste brine may need to be rebalanced to be compatible with the subsurface brine. Otherwise, an incompatible brine may present a risk of excessive scaling and improper pressure maintenance of the reservoir or well 102. However, in any case, the present techniques thus generally provide a more efficient manner of disposing byproducts including hydrogen sulfide gas from the pre-treatment unit 104 by combining them with the waste brine from the DLE process 106.

In various embodiments, there thus may be fresh water, chemical, electrical, and sorbent manufacturing requirements to operate a DLE facility using the apparatus 100. In some embodiments, if the apparatus 100 is constructed in a remote location, then delivery of chemicals or sorbents may be unreliable and/or cost of transport of any such chemicals or sorbents may be prohibitive. Therefore, in some embodiments, chemicals and sorbents may also be produced on-site.

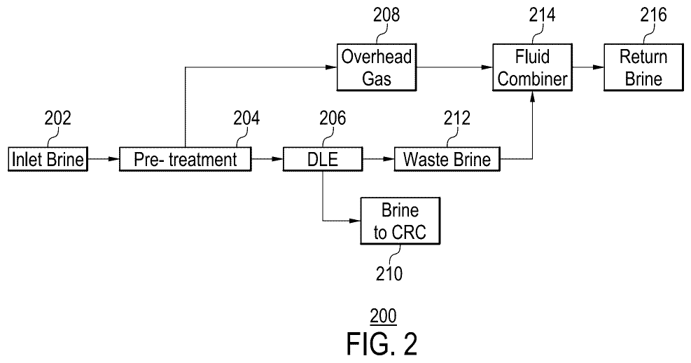

FIG. 2 is an illustration of an apparatus 200 for the disposal of hydrogen sulfide, according to an embodiment. The apparatus 200 includes an inlet brine 202 received at a pretreatment system 204. The pretreatment system 204 outputs a pretreated brine and overhead gas 204 containing hydrogen sulfide, among other gases. In various examples, the inlet brine 202 may be produced well water that also contains various ionic impurities including at least magnesium, calcium, sodium, and boron. The inlet brine 202 may also contain poisons such as hydrogen sulfide, among other undesirable components such as solids, impurities, and other organics. In various examples, the inlet brine 202 may have a concentration of hydrogen sulfide in a range of 1 ppm to 30,000 ppm by weight. In some examples, the inlet brine 202 may have a concentration of hydrogen sulfide within a range of 500-10,000 ppm by weight. By contrast, the pretreated brine may have a substantially reduced amount of such undesirable components. For example, the pretreated brine may contain from 0.01 ppm to 7,000 ppm of hydrogen sulfide by weight. In various embodiments, the exact target amount of hydrogen sulfide in the pretreated brine may depend on sorbent robustness, among other factors, such as sorbent lifetime, pipe corrosion, sorbent selectivity, ion exchange resin lifetime, filter corrosion, etc. In various embodiments, the pretreated brine is a stream that is input into a DLE process 206, such as the DLE process 106 of FIG. 1.

In various embodiments, the pretreatment system 204 further also includes a hydrogen sulfide remover to produce overhead gas 208 and pretreated brine. For example, the hydrogen sulfide remover may be a stripper. In some embodiments, the hydrogen sulfide remover may be a steam stripper. A steam stripper allows for hydrogen sulfide to be stripped out of the liquid phase and into the gas phase where the overhead gas 208 will exit the top of the tower while the brine goes to the bottom. In particular, solubility of gas is determined by the partial pressure of the gas in the fluid. Steam strippers run hot water in the vapor phase through the column. When this happens, the total vapor phase has a decrease in hydrogen sulfide content. In particular, the mass does not change, but the concentration of hydrogen sulfide does; thus, the partial pressure in the vapor phase drops. Additionally, a higher temperature changes the phase behavior to allow better kinetics of stripping A steam stripper takes advantage of this and can vary how much steam is run to vary the partial pressure of H2S in the vapor phase, and by proxy, the total concentration. For example, depending on the pH of the brine, steam can be run through a packed column to strip off the hydrogen sulfide in the brine. In various embodiments, the pH of the brine may be kept low at a more acidic level in order to minimize operating expenses and the size of the tower. For example, hydrogen sulfide is thermodynamically and kinetically more likely to be stripped away by steam at more acidic pH values. In various examples, acids such as hydrochloric acid or sulfuric acid may be added to reduce the pH of the stream. In various embodiments, the rate of steam, height of packing, and tower diameter can be optimized, as these factors may impact mass transfer rates and utility costs depending on the amount of steam. An example steam stripper is shown and described with respect to the apparatus 300 of FIG. 3.

In some embodiments, the hydrogen sulfide remover in the pretreatment unit 204 may be a gas stripper. For example, natural gas can be used in lieu of steam to strip off hydrogen sulfide. In particular, gas stripping may be used to reduce costs, such as when natural gas is readily available to be produced from the ground. In various embodiments, similar optimizations may also be made for a gas stripper as for a steam stripper.

Still referring to FIG. 2, in some embodiments, the pretreatment system 204 includes a sparging tank. In various embodiments, air sparging can be used to reduce the amount of hydrogen sulfide in the inlet brine 202. For example, controlling the amount of air injected into the sparging tank can be used to vary the hydrogen sulfide composition in the pretreated brine sent to the DLE process 206. In particular, the air is used to knockout iron, silica, and entrained gas in the inlet brine 202 via chemical reactions. In various examples, air can be bubbled into the fluid of the inlet brine 202 to precipitate the iron, silica, and remove hydrogen sulfide, among other undesirable components, such as trace amounts of magnesium, calcium, or other ions. In some embodiments, the exact rate of air injection and vessel size of the of the sparging tank can be optimized based on the target composition of the pretreated brine sent to the DLE process 206. For example, a higher rate of air injection may reduce the amount of hydrogen sulfide remaining in the pretreated brine. Similarly, holding the air injection rate constant, a smaller vessel size may reduce the amount of hydrogen sulfide remaining in the pretreated brine. Thus, one or more of these factors may be adjusted to result in an optimized composition of hydrogen sulfide in the pretreated brine.

In some embodiments, the pretreatment system 204 also includes a three-phase separator. In some examples, the three-phase separator receives the output of the sparging tank and generates hydrogen gas, a partially-treated stream, and solids. In various examples, the generated gas may include any combination of methane, ethane, propane, carbon dioxide, and nitrogen, among other gases. In various embodiments, the three-phase separator can remove organics and solids from the bottoms. For example, there may be one or more organics in the brine feed from produced wells that could cause plugging, sorbent deactivation, or cause a product to be off-specification. Example solids that may be removed include any solidified sulfates, phosphate, carbonates, silicas, sands, dirt, etc. Example organics that might be removed via the three-phrase separator include methane, ethane, propane, butanes, pentanes, hextanes, heplanes-plus, carbon dioxide, pentanes-plus, etc., in addition to hydrogen sulfide. The three-phase separator can thus be used to remove various gases, including hydrogen sulfide gas, as well as solids. In some embodiments, the three-phase-separator can remove entrained gases such as natural gas, hydrogen sulfide, and organics/oils that could have been in the underground source. In some examples, the three-phase separator may include a baffle or level control to make sure the phases are properly separated. Liquid water may come from the bottoms, which is the lowest stream in the bottom of a unit. In various examples, the bottoms may either be a solids draw from a filter, or a water stream. The bottoms have a higher density than the gas and organics streams referred to as “the overhead” and “side stream”, respectively. Thus, in various embodiments, the organics may usually settle on top and side draws may be located in each phase region to remove liquid water out of the stream. In various examples, the three-phase separator may reduce the hydrogen sulfide concentration to within the approximate range of a hundred to a few hundred ppm by weight.

In various embodiments, the DLE process 206 generates a waste brine 212 as well as a lithium-rich brine 210 that is sent for further processing at a concentration, refinement, and conversion (CRC) system, as described in FIG. 1. For example, the CRC system may include any of the processing units described in FIG. 1.

The apparatus 200 further includes a fluid combiner 214. In various embodiments, the fluid combiner 214 includes a liquid gas ejector (LGE), a compressor, or a pump. The fluid combiner 214 receives the overhead gas 208 and the waste brine 212 and generates a return brine stream 216. In various embodiments, the return brine stream 216 is disposed of in any suitable manner. For example, in some embodiments, the return brine stream 216 is reinjected into a reservoir, such as the well from which the inlet brine 202 was received, or any other reservoir. In various embodiments, the fluid combiner 214 combines the overhead gas 208 and waste brine 212 at a particular pressure. For example, OLI Simulations were run to simulate the pressure required relative to the gas composition. The fluid selected is the waste brine chemistry and not necessarily locked in, as the composition could vary. Table 1 below depicts various brine flow rate and temperature data, along with the gas speciation and rate.

TABLE 1
Brine Flow Rates with Temperature,
and Gas Specifications and Rates

| | Brine | | | | | | |
|---|---|---|---|---|---|---|---|
| | Rate | Brine | H2S | | CO2 | Pressure | CH4 |
| Case | kbd | C. | wt % | SCF/BBL | wt % | psig | wt % |
| 3 | 28.75 | 60 | 79.6 | 40.42327 | 15.8 | 5135 | 2.9 |
| 4 | 57.5 | 60 | 79.6 | 20.21164 | 15.8 | 1514.1 | 2.9 |
| 5 | 57.5 | 90 | 79.6 | 20.21164 | 15.8 | 1765.47 | 2.9 |
| 6 | 57.5 | 90 | 66.3 | 20.21164 | 31.8 | 820.26 | 0.7 |
| 9 | 86.25 | 60 | 79.6 | 13.47442 | 15.8 | 960 | 2.9 |
| 2 | 115 | 60 | 79.6 | 10.10582 | 15.8 | 640 | 2.9 |
| 7 | 115 | 90 | 66.3 | 10.10582 | 31.8 | 395.43 | 0.8 |
| 8 | 115 | 60 | 66.3 | 10.10582 | 31.8 | 317.52 | 0.7 |
| 1 | 115 | 60 | 78.8 | 10.10582 | 16.3 | 743 | 2.9 |
| 10 | 115 | 60 | 78.2 | 10.10582 | 16.9 | 759 | 2.9 |
| 11 | 115 | 60 | 65 | 10.10582 | 30.4 | 771 | 2.9 |
| 12 | 115 | 60 | 75.5 | 10.10582 | 15.4 | 1293 | 5.8 |
| 13 | 115 | 60 | 80.6 | 10.10582 | 15.4 | 538 | 0.8 |

The pressures shown in the pressure column of Table 1 are the predicted pressures that a pump, liquid vacuum ring, compressor, and/or LGE would need to get to in order to dissolve the waste gas in the return brine.

FIG. 2 is not intended to indicate that the apparatus 200 necessarily includes all elements shown therein, and, in various embodiments, additional elements may be included. For example, hydrogen sulfide removal methods are not subject to only the processes shown above. In some embodiments, other methods that can be added or some of the components can be removed depending on the required hydrogen sulfide specification for the process. In various embodiments, the apparatus 200 produces a return brine stream 216 that is the cumulative result of any number of processing steps executed to reduce hydrogen sulfide for the purposes of lithium extraction.

FIG. 3 is an apparatus 300 for the removal of hydrogen sulfide from brines using a stream stripping device. The apparatus 300 is shown receiving an inlet brine 202. In the example of FIG. 3, the inlet brine 202 has a temperature within the range of 130-210 degrees Fahrenheit and a pressure within the range of 15-600 psig. The inlet brine 202 is heated through a heat exchanger 304 before being input into a vertical vessel 302.

The outputs of the vertical vessel 302 include gases that are sent to a cooler 306 before further processing at a second vessel 308. For example, the cooler 306 cools the liquid and allows volatile gas to more easily separate from the liquid in the second vessel 308. The second vessel 308 produces wet H2S gas 310. In the example of FIG. 3, the wet H2S gas 310 has a temperature of approximately 140 degrees Fahrenheit and a pressure of approximately 15 psig. In various embodiments, the wet H2S gas 310 is sent to be mixed with a spent brine to be disposed of. The second tank 308 also produces reflux liquid that is recycled back into the vertical vessel 302.

The vertical vessel 302 also generates a hot brine. In the example of FIG. 3, the hot brine has a temperature of approximately 130-250 degrees Fahrenheit. The hot brine is sent into a heater 312, which generates steam and remaining recycled brine that is sent back into the vertical vessel 302.

The apparatus 300 includes a pump 314 that receives hot brine and pumps the hot brine into an adjustable valve 316 or back through the heat exchanger 304, based on the position of the adjustable valve 316. For example, the pump 314 is a centrifugal pump. In various embodiments, the apparatus 300 produces a tempered sweet brine 318 that is sent to a DLE unit, such as the DLE unit of FIGS. 1 and 2, for processing. In the example of FIG. 3, the tempered sweet brine 318 has a temperature of approximately 200 degrees Fahrenheit.

The example illustration of FIG. 3 is not intended to indicate that the operations of the apparatus 300 are to be executed in only one particular order, or that all of the operations of the apparatus 300 are to be included in every case.

FIG. 4 is an illustration of an apparatus 400 for the removal of hydrogen sulfide from brines under vacuum using a vacuum flash device 402. In various embodiments, the apparatus 400 includes a vacuum flash device 402 shown receiving inlet brine 202 and outputting a wet hydrogen sulfide (H2S) gas 404 and sweet brine 406. In the example of FIG. 4, the inlet brine 202 has a temperature within the range of 130-210 degrees Fahrenheit and a pressure within the range of 15-600 psig. In various examples, the inlet brine 202 may be produced well water that also contains at least lithium. The inlet brine 202 may also contain poisons, such as hydrogen sulfide. The wet H2S gas 404 may include water vapor containing H2S, among other poisons.

In various embodiments, the vacuum flash device 402 includes a flash vessel and a vacuum system coupled to the flash vessel. For example, the vacuum system may be a liquid ring vacuum pump (LRVP), steam vacuum ejector, a liquid ejector system, or similar vacuum system.

In various embodiments, the vacuum flash device 402 receives an inlet brine 202 and generates sweet brine 404 with a reduced concentration of hydrogen sulfide. For example, a flash separator was simulated under vacuum conditions at 70 mm Hg abs and shown to achieve a reduction of hydrogen sulfide from 15 ppm to less than 1 ppm in the sweet brine 406, depending on the original concentration of hydrogen sulfide in the inlet brine 202. In various examples, the amount of hydrogen sulfide removed may vary depending on the concentration of hydrogen sulfide in the inlet brine 202, the operating pressure of the vacuum system, and the size of the flash vessel. In the example of FIG. 4, the operating pressure of the vacuum flash device 402 is within the approximate range of 0.5 to 7 psig and at a temperature within the range of approximately 55 to 170 degrees Fahrenheit. In some embodiments, the size of the vessel of the vacuum flash device 402 can be optimized based on the concentration of hydrogen sulfide in the inlet brine 202, the operating pressure of the vacuum system, and the target concentration of hydrogen sulfide in the sweet brine 406. Similarly, in some embodiments, the operating pressure of the vacuum system can be optimized based on the concentration of hydrogen sulfide in the inlet brine 202, the size of the flash vessel, and the target concentration of hydrogen sulfide in the sweet brine 406. In various embodiments, the operating conditions and target output hydrogen sulfide content can thus be optimized to meet DLE inlet specifications. For example, the DLE inlet specifications may include a maximum hydrogen sulfide concentration, among other specifications. In various examples, the DLE inlet specifications may also have a pH range, a TOC (total organic content) range, and temperature and pressure specifications/ranges, or any combination thereof.

The wet H2S gas 404 may be sent to a fluid combiner to be mixed with a spent brine for disposal, as described in the examples of FIGS. 1, 2, 5, and 6. For example, the spent brine may be the byproduct of processing of the sweet brine 406 at a DLE unit. The sweet brine 406 may have substantially reduced poisons, such as hydrogen sulfide, that would otherwise affect the performance or durability of the DLE unit. In this manner, the apparatus 400 may increase performance and reliability of DLE units. For example, the apparatus 400 may result in more optimal lithium extraction when integrated with a DLE circuit due to prolonged sorbent lifetime and improved lithium selectivity and extraction.

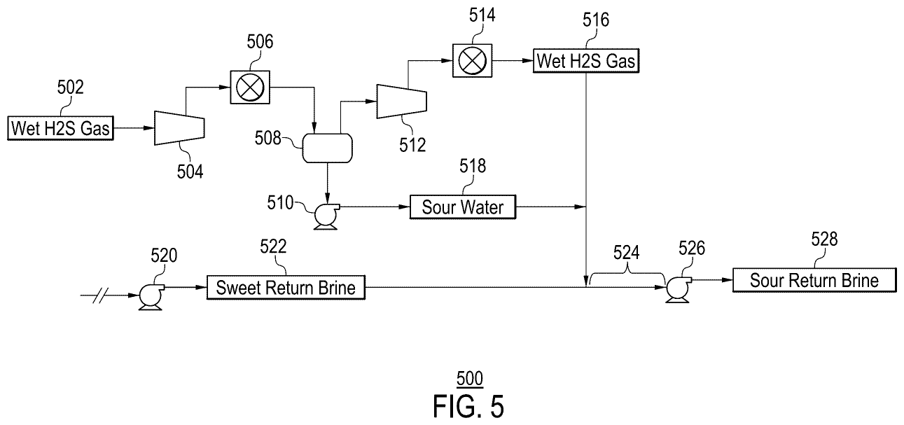

FIG. 5 is an illustration of an apparatus 500 for separate acid gas compression and reinjection, according to an embodiment. The apparatus 500 can generally be used to return gas into the reservoir, with a liquid stream as an absorber. The apparatus 500 is shown receiving a wet H2S gas 502. In the example of FIG. 5, the wet H2S gas 502 has a temperature of approximately 140 degrees Fahrenheit and a pressure of about 15 psig. The wet H2S gas 502 is sent into a first compressor 504 and cooler 506. The cooled output of the cooler 506 is sent into a vessel 508. The vessel 508 outputs liquid that is sent to a pump 510 and gas sent to a second compressor 512. For example, the pump 510 is a centrifugal pump. The compressed output of the second compressor 512 is sent into a second cooler 514. The second cooler 514 outputs a wet H2S gas 516 with a higher pressure. In the example of FIG. 5, the wet H2S gas 516 has a pressure of approximately 105 psig with a temperature of approximately 140 degrees Fahrenheit.

In various embodiments, the wet H2S gas 516 is mixed with sour water 518 from the pump 510. A second pump 520 provides sweet return brine 522, which is mixed with the wet H2S gas 516 and sour water 518 within an absorption zone 524. For example, the second pump 520 is also a centrifugal pump. In the example of FIG. 5, the sweet return brine 522 has a temperature of approximately 120 degrees Fahrenheit and a pressure of approximately 80 psig.

FIG. 5 shows an example case for the acid gas compression with sample temperature and pressures. In various embodiments, any range of compositions may be treated, which would change the required temperatures and pressures. In general, the wet H2S gas 502 is taken and compressed up to the required reservoir pressure, then mixed with existing brine and sent back into the ground. In various embodiments, the brine flow rate, temperature, and pressure of the sweet return brine 522 may vary to some degree and would need to be enough to have the entire wet H2S gas 502 stream absorbed in the sweet return brine 522 before being sent to the pump 526 for final pressurization. For example, the pump 526 is also a centrifugal pump. In the example of FIG. 5, the sour return brine 528 has a temperature of approximately 130 degrees Fahrenheit with a pressure of approximately 2,000 psig. In various embodiments, the pressure of sour return brine 528 can be adjusted as needed for a specific configuration of apparatus 500. Thus, in various embodiments, various liquid waste streams may be used as an absorption fluid for various waste gas streams.

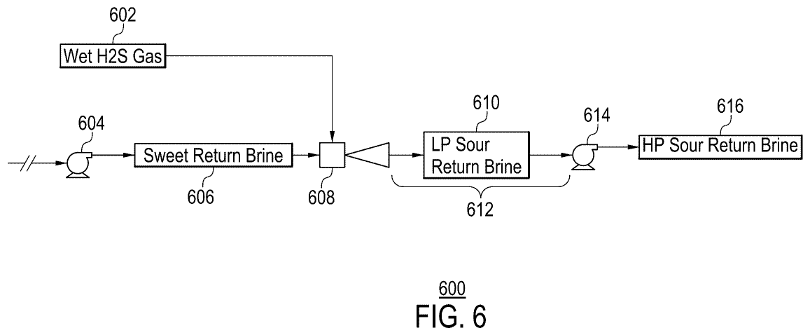

FIG. 6 is an illustration of an apparatus 600 for combined acid gas compression and reinjection using a liquid gas ejector, according to an embodiment. The apparatus 600 is shown receiving a receiving a wet H2S gas 602. In the example of FIG. 6, the wet H2S gas 602 has a temperature within the range of approximately 40-200 degrees Fahrenheit and a pressure of about 0.5-20 psig. A pump 604 of the apparatus 600 provides a sweet return brine 606. In the example of FIG. 6, the sweet return brine 606 has a temperature of approximately 120 degrees Fahrenheit and a pressure of approximately 80 psig.

In particular, to reduce the electrical cost of compression, the LGE is used in conjunction with the sweet return brine 606 to mix with the wet H2S gas 602. In various embodiments, one or more LGEs 608 are used in series to achieve the desired pressure. In the example of FIG. 6, the low pressure (LP) sour return brine 610 generated by the LGE 608 has a temperature of approximately 130 degrees Fahrenheit and a pressure of approximately 80 psig. The gases in the LP sour return brine 610 are allowed to absorb into the brine within an absorption zone 612.

A second pump 614 is used to increased the pressure of the low pressure sour return brine 610 to generate a high pressure (HP) sour return brine 616. For example, the second pump 614 is also a centrifugal pump. In the example of FIG. 6, the HP sour return brine 616 has a temperature of approximately 140 degrees Fahrenheit and a pressure of approximately 2000 psig. In various embodiments, the pump 614 can be configured to increase or decrease the pressure of the HP sour return brine 616 as needed for a specific configuration.

The apparatus 600 is generally used to return gas into a reservoir, with a liquid gas cjector (LGE) 608 decreasing the compression energy required. This would be further advantaged over FIG. 5, and would be preferable in an area with a low amount of electricity available, in addition to having lower capital costs than in for the compressors in FIG. 5.

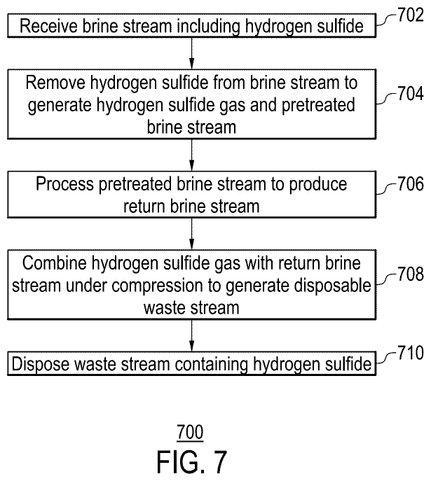

FIG. 7 is a process flow diagram of a method 700 for producing a direct lithium extraction feed. The method 700 can be implemented in a lithium extraction system, such as that described in FIG. 1, using any suitable pretreatment system, such as the example apparatuses 200-400 described in FIGS. 2-4. For example, the method 700 can be used to efficiently dispose of hydrogen sulfide resulting from the pretreatment process 104 of FIG. 1. In various embodiments, the method 700 can alternatively be used to efficiently dispose of any other source of hydrogen sulfide using a brine stream, such as a brine stream generated by a lithium extraction process.

At block 702, brine stream is received. For example, the brine stream may be received from a well. As one example, the brine may be an untreated brine from a deep subsurface well, such as a Smackover brine. In various examples, the brine may include hydrogen sulfide, in addition to magnesium, calcium, sodium, and boron.

At block 704, hydrogen sulfide is removed from the brine stream to generate hydrogen sulfide gas and a pretreated brine stream. In some embodiments, the air or other gas may be passed through a sparging tank to remove the hydrogen sulfide. For example, the brine stream may be sent through a sparging tank to pass a gas through the brine to knock out an amount of hydrogen sulfide gas. For example, the gas may be air. In some embodiments, the hydrogen sulfide is separated from the pretreated brine stream using a sour water stripper. In some embodiments, the hydrogen sulfide reduced from the brine stream using a vacuum flash. In some embodiments, the hydrogen sulfide is reduced from the brine stream via a three-phase separator.

At block 706, the pretreated brine stream is processed to produce a return brine stream. For example, the pretreated brine stream may be processed at a direct lithium extraction unit to produce the return brine stream and a lithium rich stream.

At block 708, the hydrogen sulfide gas is combined with the return brine stream under compression to generate a disposable waste stream. For example, the hydrogen sulfide gas may be combined with the return brine stream under pressure to generate the disposable waste stream. In some embodiments, the return brine stream is used as a motive fluid for absorption of the hydrogen sulfide gas to reduce absorption compression. In various examples, any other waste gases generated by the system may similarly be included in the disposable waste stream. For example, such additional waste gases may include CO2, CH4, NH3, N2, O2, C2H6, and CO.

At block 710, the waste stream containing the hydrogen sulfide is disposed of. In various embodiments, the waste stream is disposed of back into a well, or reservoir, or any other suitable location. For example, in some embodiments, the waste stream is reinjected back into a reservoir. The return brine stream is thus used as an efficient means for transporting the various waste gases back into a well or reservoir.

The process flow diagram of FIG. 7 is not intended to indicate that the processes of the method 700 are to be executed in any particular order, or that all of the processes of the method 700 are to be included in every case. Additionally, the method 700 can include any suitable additional processing of the brine. For example, in some embodiments, the method 700 may include the removing various other impurities from the brine stream.

### Embodiments of Present Techniques

In one or more embodiments, the present techniques may be susceptible to various modifications and alternative forms, such as the following embodiments as noted in paragraphs 1 to 20:
1. An apparatus includes a system to receive a brine stream including hydrogen sulfide. The apparatus includes a system to remove the hydrogen sulfide from the brine stream to generate hydrogen sulfide gas and a pretreated brine stream. The apparatus includes a system to process the pretreated brine stream to produce a return brine stream. The apparatus includes a system to combine the hydrogen sulfide gas with the return brine stream under compression to generate a disposable waste stream.
2. The apparatus of paragraph 1, further including a compressor to compress the hydrogen sulfide gas.
3. The apparatus of any of paragraphs 1-2, further including a pump to compress the hydrogen sulfide gas.
4. The apparatus of any of paragraphs 1-3, further including a liquid gas ejector to compress the hydrogen sulfide gas.
5. The apparatus of any of paragraphs 1-4, further including a lithium extraction unit to process the pretreated brine stream and produce the return brine stream, wherein the return brine stream includes a byproduct of a lithium extraction process.
6. The apparatus of any of paragraphs 1-5, further including a sour water stripper to remove the hydrogen sulfide from the brine stream.
7. The apparatus of any of paragraphs 1-6, further including a vacuum flash unit to remove the hydrogen sulfide from the brine stream.
8. The apparatus of any of paragraphs 1-7, further including a liquid gas ejector to remove the hydrogen sulfide from the brine stream.
9. The apparatus of any of paragraphs 1-8, further including a pump to reinject the disposable waste stream into a reservoir.
10. The apparatus of any of paragraphs 1-9, wherein a concentration of hydrogen sulfide in the disposable waste stream includes a concentration in a range from 0.01 to 500 parts per million (ppm) by weight.
11. A method includes receiving a brine stream including hydrogen sulfide. The method includes removing the hydrogen sulfide from the brine stream to generate hydrogen sulfide gas and a pretreated brine stream. The method includes processing the pretreated brine stream to produce a return brine stream. The method includes combining the hydrogen sulfide gas with the return brine stream under compression to generate a disposable waste stream.
12. The method of claim 11, further including disposing the disposable waste stream.
13. The method of any of paragraphs 11-12, further including reinjecting the disposable waste stream into a reservoir.
14. The method of any of paragraphs 11-13, wherein combining the hydrogen sulfide gas with the return brine stream includes using the return brine stream as a motive fluid for absorption of the hydrogen sulfide gas to reduce absorption compression.
15. The method of any of paragraphs 11-14, wherein processing the pretreated brine stream includes processing the pretreated brine stream via a lithium extraction unit to produce the return brine stream.
16. The method of any of paragraphs 11-15, wherein removing the hydrogen sulfide includes separating the hydrogen sulfide from the pretreated brine stream using a sour water stripper.
17. The method of any of paragraphs 11-16, wherein removing the hydrogen sulfide includes reducing the hydrogen sulfide using a vacuum flash.
18. The method of any of paragraphs 11-17, wherein removing the hydrogen sulfide includes reducing the hydrogen sulfide via a three-phase separator.
19. The method of any of paragraphs 11-18, wherein removing the hydrogen sulfide includes sending the brine water through a sparging tank to pass a gas through the brine to knock out an amount of hydrogen sulfide gas.
20. A return brine composition includes a treated brine having a concentration of hydrogen sulfide within a range of 0.01 to 7,000 parts per million (ppm) by weight, and a concentration of lithium within a range of 0.01 to 1,000 ppm by weight.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. An apparatus, comprising:
a system to receive a brine stream comprising hydrogen sulfide;
a system to remove the hydrogen sulfide from the brine stream to generate hydrogen sulfide gas and a pretreated brine stream;
a system to process the pretreated brine stream to produce a return brine stream; and
a system to combine the hydrogen sulfide gas with the return brine stream under compression to generate a disposable waste stream.

2. The apparatus of claim 1, comprising a compressor to compress the hydrogen sulfide gas.

3. The apparatus of claim 1, comprising a pump to compress the hydrogen sulfide gas.

4. The apparatus of claim 1, comprising a liquid gas ejector to compress the hydrogen sulfide gas.

5. The apparatus of claim 1, comprising a lithium extraction unit to process the pretreated brine stream and produce the return brine stream, wherein the return brine stream comprises a byproduct of a lithium extraction process.

6. The apparatus of claim 1, comprising a sour water stripper to remove the hydrogen sulfide from the brine stream.

7. The apparatus of claim 1, comprising a vacuum flash unit to remove the hydrogen sulfide from the brine stream.

8. The apparatus of claim 1, comprising a liquid gas ejector to remove the hydrogen sulfide from the brine stream.

9. The apparatus of claim 1, comprising a pump to reinject the disposable waste stream into a reservoir.

10. The apparatus of claim 1, wherein a concentration of hydrogen sulfide in the disposable waste stream comprises a concentration in a range from 0.01 to 500 parts per million (ppm) by weight.

11. A method, comprising:
receiving a brine stream comprising hydrogen sulfide;
removing the hydrogen sulfide from the brine stream to generate hydrogen sulfide gas and a pretreated brine stream;
processing the pretreated brine stream to produce a return brine stream; and
combining the hydrogen sulfide gas with the return brine stream under compression to generate a disposable waste stream.

12. The method of claim 11, comprising disposing the disposable waste stream.

13. The method of claim 11, comprising reinjecting the disposable waste stream into a reservoir.

14. The method of claim 11, wherein combining the hydrogen sulfide gas with the return brine stream comprises using the return brine stream as a motive fluid for absorption of the hydrogen sulfide gas to reduce absorption compression.

15. The method of claim 11, wherein processing the pretreated brine stream comprises processing the pretreated brine stream via a lithium extraction unit to produce the return brine stream.

16. The method of claim 11, wherein removing the hydrogen sulfide comprises separating the hydrogen sulfide from the pretreated brine stream using a sour water stripper.

17. The method of claim 11, wherein removing the hydrogen sulfide comprises reducing the hydrogen sulfide using a vacuum flash.

18. The method of claim 11, wherein removing the hydrogen sulfide comprises reducing the hydrogen sulfide via a three-phase separator.

19. The method of claim 11, wherein removing the hydrogen sulfide comprises sending the brine water through a sparging tank to pass a gas through the brine to knock out an amount of hydrogen sulfide gas.

20. A return brine composition, the composition comprising a treated brine having a concentration of hydrogen sulfide within a range of 0.01 to 7,000 parts per million (ppm) by weight, and a concentration of lithium within a range of 0.01 to 1,000 ppm by weight.
